(19) United States
(12) Patent Application Publication
(10) Pub. No.: US 2006/0126861 A1
(43) Pub. Date: Jun. 15, 2006

(54) Personal listening device for events

(75) Inventor: Mark Saliterman, Edina, MN (US)

Correspondence Address: ALTERA LAW GROUP, LLC, 6500 CITY WEST PARKWAY, SUITE 100, MINNEAPOLIS, MN, 55344-7704, US

(73) Assignee: Front Row Advantage, Inc., St. Louis Park, MN (US)

(21) Appl. No.: 11/340,254

(22) Filed: Jan. 26, 2006

Related U.S. Application Data
(63) Continuation-in-part of application No. 09/716,314, filed on Nov. 20, 2000.

(51) Int. Cl. H04B 3/00; H04B 5/00

(52) U.S. Cl. 381/77; 381/79; 381/82

(57) ABSTRACT

Herein is disclosed a method and apparatus for transmitting sound generated at an event to those in attendance at the event. This is accomplished by a system that collects an acoustic audio signal generated at a first location within a fixed space. The system also conditions the audio signal without introducing audio signals generated from outside said first location. Finally, the system transmits the conditioned audio signal to a receiver worn by at least one of a plurality of individuals within the aforementioned fixed space. This invention is particularly useful in settings such as a football stadium, a basketball arena, a hockey arena, a baseball stadium, an auditorium, a performance area in a restaurant or cruise ship, a soccer arena, a boxing ring or wrestling ring, an automotive racing track, or any other space within which a performance takes place.

### CROSS-REFERENCE TO RELATED APPLICATIONS

This present application is a continuation-in-part of U.S. patent application Ser. No. 09/716314, filed Nov. 20, 2000.

### TECHNICAL FIELD

The invention disclosed herein relates to sound distribution systems, and more particularly to a system and method for real-time distribution of sounds, commentary or instructions emanating from an event or to those in attendance at the event.

### BACKGROUND OF THE INVENTION

Entertainment and Sporting events are very competitive businesses. There are typically more venues than attendees and those venues which can create greater fan interaction and excitement have the advantage. Fans hungrily devour sports information and discuss the latest game. To serve this ravenous interest, various enterprises have sprung up, including sports-oriented networks, websites and magazines. The goal of each of these services is to give each fan what he or she most desires: to be closer to the game.

Nowhere can a fan be closer to a game than by actually attending the game in a front-row seat. With a front-row seat, every nuance of the game can be seen and heard. Coaches and players can be overheard. Players can be heard shouting encouragements and discussing strategy. A front-row seat permits a fan to experience the game in a personal and dramatic way. Front-row seats are exciting. Unfortunately, front-row seats are not available to everyone.

Fans who attend sporting events, but are not lucky enough to possess front-row tickets find their experiences to be more remote. Small gestures by the players and coaches cannot be seen from a distance. The various sounds of the game go unheard. The shouts of players become inaudible. It is impossible to hear coaches and players discussing the game. Even the sound of a bone-crunching tackle cannot be heard. Quite simply, the game loses some of its drama.

To counteract the negative effects of distance, fans have employed many strategies. Many fans bring binoculars to aid them in seeing the visual nuances lost with distance. Other fans bring radios to permit them to hear a broadcast of the game. Radio broadcasts are not effective surrogates for a front-row seat, however. Radio broadcasts do not carry sounds collected from the field of play, nor do such broadcasts carry sounds collected from areas immediately surrounding the field of play (such as dugouts or team benches). Additionally, radio broadcasts are typically delayed so that they are not synchronized with the game as it actually occurs. An additional drawback of radio broadcasts is that they carry a narrative of the game, an often unwanted feature for a fan that is already able to discern the major developments of the game.

Some fans bring hand-held televisions to sporting events. Hand-held televisions also have drawbacks, though. They are small and require the fan to remove his attention from the field of play, instead turning it to the television. Additionally, the broadcast is delayed. Most importantly, when viewing a televised sporting event, the fan is receiving a produced version of the game, rather than a true-to-life front-row experience.

The inadequacies of radio and television broadcast are reflected in the attendance figures for professional sports. Many professional sports teams fail to sell-out a significant number of their games, leading to several undesirable results. Often, in response to low attendance figures, professional sports organizations are forced to lower ticket prices for seats that offer a less intimate game-time experience. Some leagues impose television blackouts with respect to games that fail to sell-out, thereby inducing further losses due to lost television revenue. Even if tickets are sold, non-attendance results in lost concession and souvenir sales. Low revenues, whether the low revenues stem from unsold tickets or from non-attendance, are also a major factor in the relocation of professional sports franchises. Relocation of professional sports franchises is troubling on two fronts. When a professional sports franchise relocates, the community that loses its franchise loses a source of community pride and entertainment. Additionally, professional sports leagues that permit its franchises to move often suffer from fan cynicism, with many fans choosing to turn away from the particular sport entirely, thus resulting in further lost revenue for the league as a whole.

To preserve fan interest in and attendance of sports events, there exists a need for a method or system for providing fans with an experience approximating the close, exciting, and personal feel of a front-row ticket.

In addition to on the ground sounds, there are opportunities to capture “back stage” or locker room talk of the players. It would likewise enhance the experience to capture and transmit such sounds to the attendees.

Attendees can also be distracted during events (often by noise/cheering, etc.) and miss an important phrase, signal, call or play. It would be extremely helpful if a device could record and playback a short previous segment of the event. This would be quite convenient in a movie, for example where, a critical line may be missed by a distraction, such as a crying baby, another attendee talking loudly or just the distraction of a spilled soft drink at a critical moment. A similar circumstance could arise in a college lecture where taking notes may distract the listener from hearing a key phrase.

At an arena event, there are always unsold seats. There needs to be an orderly way to allow attendee to switch seats. It would be useful for an attendee, by selective broadcast (coded) to be advised of the exact seat location of an empty preferred seat without disturbing or advising others. The seat upgrade could also generate revenue.

Attendees at events (fans) often wish to purchase food at the event (indeed it may be the highlight of the event), but many arenas/stadiums have very poor aisle access making if cumbersome to get up and leave to purchase food. An interactive system coded to know the purchaser's seat location would be helpful in pre-ordering (for pickup or delivery) of food or other purchasable items.

Attendees often bring their own radio to receive play-by-play or commentary about the event. It would be helpful if a device was available which could integrate the above on the ground sounds with radio broadcasts and prioritize either according to user tastes.

Legal and other restrictions on the transmission of on the ground sound (play action) may be necessary to prevent opposing teams from graining advantage from such information. Thus a system (such as a proximity system) that could restrict which sounds can be re-transmitted to attendees and which need to be squelched would be desirable. For example, a coach talking to a team player may need to be suppressed from rebroadcast.

Besides sporting events, there are many other situations where direct to attendee broadcast of information would be highly desirable.

For example tour groups may have difficulty hearing their tour leader when spread out over a large area or the tour leader may be required to whisper (such as in churches). Likewise, the tour participants may not all speak the same language and even though the tour leader may be multilingual, it would be convenient if the tour guide could specifically direct his/her talk in each language to each linguistic group separately. Finally a tour guild may which to integrate information provided by the site (museum/historic site, etc.) into his/her talk. Sound clips may be available to the tour by short range radio and it would be desirable to be able to provide individual receivers which could tap into such feeds as the tour operator or participant desires.

Movie theaters (cinemas) may find such a system likewise useful to provide talking commentary by the director, for foreign languages or many other differentiations.

In addition to the above needs, event organizers are always looking for revenue enhancement opportunities. A system which provided revenue by sales of equipment and memorabilia would be highly desirable.

### SUMMARY OF THE INVENTION

The method and apparatus in accordance with the present invention solves the aforementioned problem and other problems by transmitting sound generated at an event to those in attendance at the event. This is accomplished by a system that collects an acoustic audio signal generated at a first location within a fixed space. In some embodiments, the system also conditions the audio signal without introducing audio signals generated from outside said first location. Finally, in some embodiments, the system transmits the conditioned audio signal to a receiver worn by at least one of a plurality of individuals within the aforementioned fixed space. This invention is particularly useful in settings such as a football stadium, a basketball arena, a hockey arena, a baseball stadium, an auditorium, a performance area in a restaurant or cruise ship, a soccer arena, a boxing ring or wrestling ring, an automotive racing track, or any other space within which a performance takes place.

In another embodiment of the invention, the system collects an audio signal generated at a first location within a fixed space. The system then transmits, under a first transmission protocol uniquely associated with a particular event and first location within the fixed space, the audio signal collected from the first location to a receiver worn by at least one of a plurality of individuals within the fixed space. Finally, the audio signal is received by a receiver that is configured to operate under the aforementioned first transmission protocol.

In yet another embodiment of the invention, the system collects an audio signal generated at a first location within a fixed space at a particular event. Next, the system transmits, under a particular transmission protocol uniquely associated with the particular event, the audio signal to a receiver worn by at least one of a plurality of individuals within the aforementioned fixed space and at a distance from the aforementioned first location such that said individual would not otherwise hear the audio signal generated at the first location. Finally, a fee is charged to individuals in attendance at an event within the aforementioned fixed space in exchange for the aforementioned earpiece.

In yet another embodiment of the invention, the system collects an audio signal generated at a first location within a fixed space at a particular event. Next, the system transmits, under a particular transmission protocol uniquely associated with the particular event, the audio signal to a receiver worn by at least one of a plurality of individuals within the aforementioned fixed space. Finally, revenue is derived from the distribution of the earpiece.

In yet another embodiment of the invention, a system for distribution of sound within a fixed space is comprised of one or more audio collection units for collecting one or more audio signals from one or more locations with a fixed space. Additionally, one or more signal conditioning units are coupled to the aforementioned one or more audio collection units for conditioning the aforementioned one or more audio signals without introducing an audio signal generated from outside the aforementioned one or more locations. Finally, one or more transmitters are configured and arranged to transmit the aforementioned one or more audio signals under one or more transmission protocols, such that each of the aforementioned one or more audio signals is transmitted under its own transmission protocol, with the transmission protocol under which each of the aforementioned one or more audio signals is transmitted being uniquely associated with a particular event.

### BRIEF DESCRIPTION OF THE DRAWINGS

FIG. 1 depicts a system and method for collecting sound generated at one location within a defined space and transmitting it to another location within that defined space.

FIG. 2 depicts a system and method for collecting sound generated at more than one location within a defined space and transmitting it to another location within that defined space.

FIG. 3 depicts a system and method for the use of particular transmission protocols on an event-by-event basis.

FIGS. 4A-4C depict various embodiments of transmitters in accordance with the present invention.

FIGS. 5A-5C depict various embodiments of receivers in accordance with the present invention.

FIG. 6 depicts a system and method for the use of multiple transmission protocols to enable a microphone-by-microphone selection.

FIG. 7 depicts one business method in accordance with the present invention.

FIG. 8 is a front view of one embodiment of the present invention;

FIG. 9 is back view of the subject of FIG. 8;

FIG. 10 is a front view with a card ready for insertion;

FIG. 11 is a view like FIG. 10 with the card inserted;

FIG. 12 is a view like FIG. 8 with the battery compartment shown in dotted lines;

FIG. 13 is a view like FIG. 12 except the battery insulator is shown removed;

FIG. 14 is a side view, with card removed of the device in FIG. 10; and

FIG. 15 is a side view, with card removed of the device in FIG. 11.

### DETAILED DESCRIPTION OF THE INVENTION

For convenience, the preferred embodiments are described for use with sporting events, but this invention is not limited to such uses as has been explained in the background above.

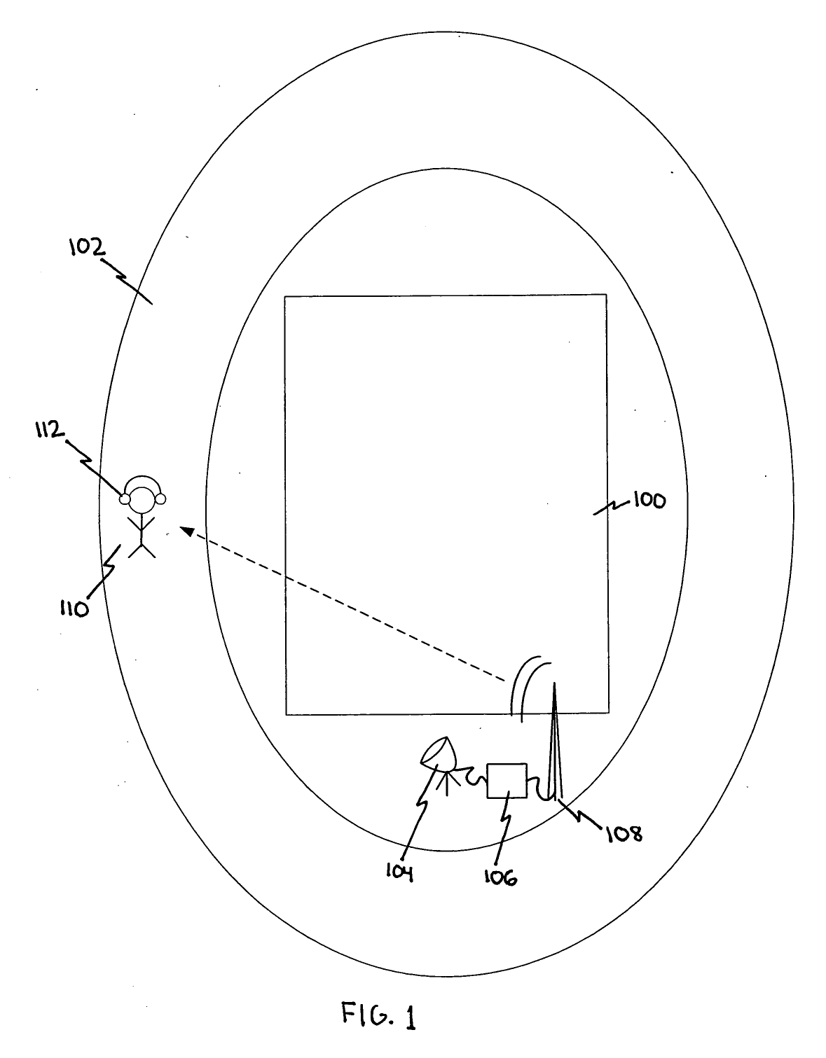

FIG. 1 illustrates the principle that sound that is generated at a point of interest within a fixed space can be collected and redistributed to members of an audience within that fixed space. Generally, the aforementioned fixed space is defined by the boundary of the audience in attendance at an event. For example, if the event in question is a football game, the point of interest at which sound is being collected might be the line of scrimmage, and the fixed space might be defined by the football stadium in which the audience is contained. FIG. 1 diagrammatically represents a football arena as one example of an environment in which the system and method could operate. One skilled in the art would understand that the system described herein could operate in any fixed space. On the field 100 of play, sounds are generated by athletes engaged in the activity of playing football (for example, calling out audibles, engaging in banter, or making vicious tackles). Sounds are also generated up on areas immediately surrounding the field 100 such as players' benches and visiting and home sidelines. Fans are illustrated as sitting in stands 102. Some fans are seated in regions too remote from the field 100 of play to be able to hear the noises generated thereon or thereabout. Accordingly, the system and method collects the sounds from immediately on the field or thereabout the field and redistributes that sound to the fans in the bleachers 102. Some of the fans may be situated in such a fashion that they could not ordinarily hear some of the sounds being transmitted.

The system is generally comprised of an audio collection unit 104 (which receives an acoustic signal and transduces it into an electrical signal), a signal conditioning unit 106 (which receives the transduced electrical signal from one or more audio collection units 104 and filters, mixes and/or switches the signal(s) to produce an appropriate signal for transmission), and a transmitter 108 (which transmits the signal provided by the signal conditioning unit 106). The audio collection unit 104 may be comprised of any form of microphone suitable for collecting noise from the field 100 of play and regions immediately thereabout. One example of such a microphone is a parabolic microphone, as is customarily used for collecting sound during sports broadcasts.

The signal conditioning unit 106 may include mixers for adjusting the level of multiple sources of audio signals, filters for filtering out frequency content not desirable in an audio signal, and switches for selecting amongst audio sources. Signal conditioning unit 106 serves as an interface between audio collection unit 104 and transmitter 108 and is therefore coupled either directly or indirectly on its input side to audio collection unit 104 and either indirectly or directly on its output side to transmitter 108.

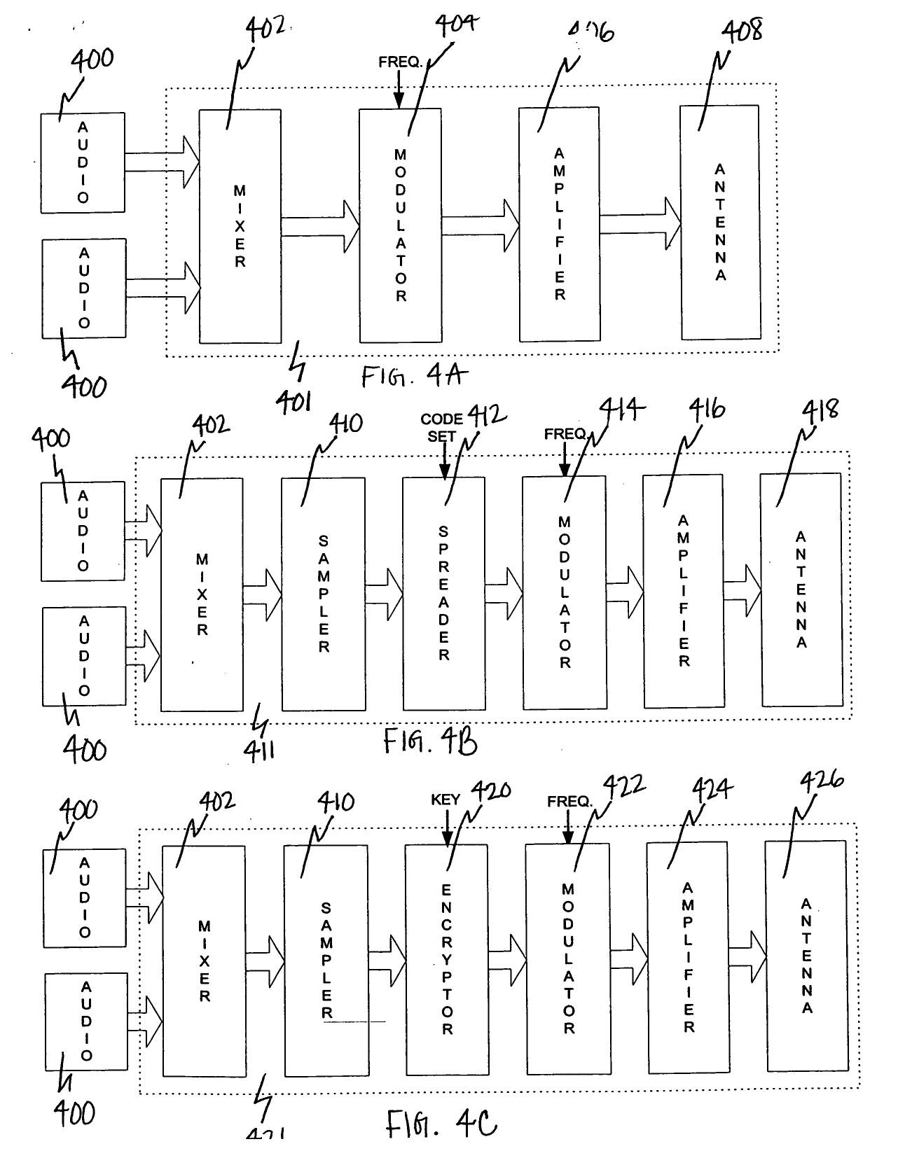

Transmitter 108 receives the conditioned signal from signal conditioning unit 106, amplifies the signal, modulates the signal, and transmits the signal throughout the fixed space (in this case a football arena). A representative fan 110 is shown sitting in bleachers 102 wearing a receiver 112. Receiver 112 is configured and arranged to receive the signal transmitted by transmitter 108 and deliver an audio signal to fan 110. Fan 110 is thereby provided with an audio source simulating the effect of his having sat in a front-row seat or having been immediately on or about the field 100 of play. Transmitter 108 is shown in greater detail in FIGS. 4A-4C.

As stated earlier, FIG. 1 depicts a football arena for illustrative purposes only. The system and method described in FIG. 1 would be equally well suited to an enclosed space defined by a basketball arena, a hockey arena, a baseball stadium, an auditorium, a performance area in a restaurant or cruise ship, a soccer arena, a boxing ring or wrestling ring, an automotive racing track, or any other space within which a performance takes place.

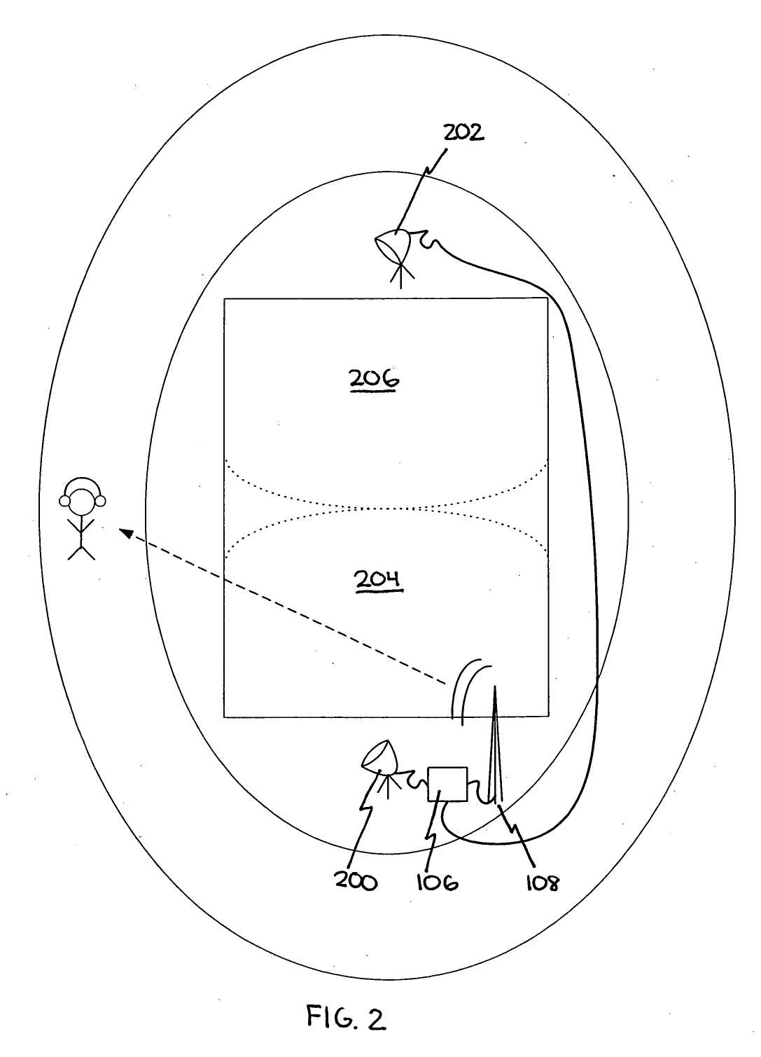

FIG. 2 illustrates the principle that sound may be collected from many points on or about the field. In FIG. 2, the audio collection unit is shown as being comprised of two parabolic microphones 200, 202. The field 100 of play is shown as being divided into two regions 204, 206. Region 204 is primarily recorded using parabolic microphone 200. Similarly, region 206 is primarily recorded using parabolic microphone 202. Parabolic microphones 200, 202 are connected on their output end either directly or indirectly to signal conditioning unit 106 which receives the signals, potentially mixing, filtering and switching the signals, and then outputs a conditioned signal to transmitter 108. The signal transmitted to fan 110 may thus be produced by switching and mixing between various microphones 200, 202.

For example, rather than moving the audio collection unit along the field as the point of interest changed, as might happen when a football team moves up and down a field, multiple microphones 200, 202 may be situated along the football field. As the ball is moved up or down the football field, a producer may, using the signal conditioning unit 106, raise the signal level of a microphone that collects sound from a region of the field upon which the ball is located. Microphones located near a region of the field more remote from the ball may be progressively mixed down or switched off altogether. Additionally, a sideline conversation of particular interest may be mixed up, mixed down or turned off altogether. Thus, in keeping with the principle just discussed, it follows that although the field 100 is shown as being divided into two regions 204, 206 recorded by two parabolic microphones 200, 202, the field 100 may actually be divided into as many regions as is necessary to conveniently record the game. It is understood that each region will be recorded by its own microphone.

Although FIG. 2 shows each microphone 200, 202 as being physically connected via a cable to signal conditioning unit 106, it is understood that this connection may be indirect and accomplished via transmission.

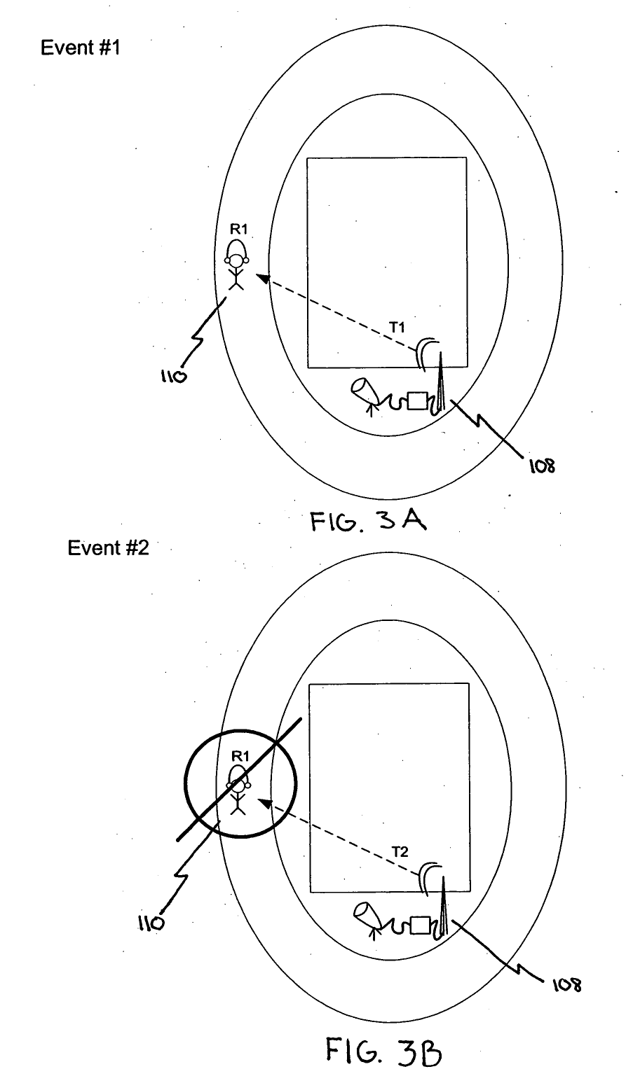

One anticipated method for the use of the system depicted in FIGS. 1 and 2 involves the sale of receiver 112 to one or more fans 110 in attendance at a particular event within the stadium. Since this profit model is reliant upon fan 110 purchasing a receiver 112 for each event that fan 110 attends, it is important that a receiver 112 sold to a fan 110 for a particular event not be functional during a following event. FIG. 3 illustrates a system and method designed with this constraint in mind.

As can be seen from FIG. 3A, during a first event, transmitter 108 transmits its collected signal via a first transmission protocol uniquely associated with the first event. The fan 110 in attendance at the first event is wearing a receiver designed to operate and receive transmissions made in accordance with the first transmission protocol. During a second event, depicted in FIG. 3B, however, transmitter 108 will be transmitting under a second transmission protocol, so that if a fan 110 in attendance at the second event tries to use a receiver from the first event, that fan 110 will be unable to receive the transmission that is being broadcasted. The inoperability of the receiver purchased at the first event stems from the fact that that receiver was designed to receive transmissions made in accordance with the first transmission protocol, but the broadcast at the second event is made in accordance with a second transmission protocol. Therefore if a fan 110 wishes to receive the service of having sounds collected on or about the playing field transmitted to him, he must purchase a receiver at the second event, and may not receive the transmission using a receiver purchased at the first event.

FIGS. 4A-4C depict three transmitters 401, 411, 421 capable of transmission under varying transmission protocols. One skilled in the art would understand that the transmitters depicted in FIGS. 4A, 4B and 4C are exemplary only and that many other such transmitters could serve the purpose of transmitting using differing transmission protocols from event to event.

Turning to FIG. 4A, therein is depicted a transmitter 401 which alters its transmission protocol by simply carrying its signal on a different carrier frequency from game to game. The transmitter 401 of FIG. 4A is shown as receiving two audio sources 400. In principle, the transmitter 401 of FIG. 4A could receive any number of audio sources, including only one audio source. The audio sources 400 are supplied to a mixer 402. The mixer 402 adjusts the relative signal strength of each audio source 400 received by it. The mixer 402 may also have switching ability, allowing the mixer 402 to completely turn off a particular audio source 400. Mixer 402 may also contain filters designed to eliminate signal components and frequency ranges that are undesired. Mixer 402 may also be embodied in an electrical component separate from transmitter 401. For example, one skilled in the art would understand that mixer 402 may be embodied within signal conditioning unit 106. Modulator 404 is coupled to the output of mixer 402 and receives the mixed signal, using that mixed signal to modulate a carrier signal. The frequency of the carrier signal to be modulated is a selectable value. The output of modulator 404 may be filtered to eliminate signal components in frequency ranges that are undesired. The output of modulator 404 is then fed to amplifier 406. Amplifier 406 is designed to receive a signal from modulator 404 and amplify it by a certain gain factor, such that when the output of amplifier 406 is fed to antenna 408, the resultant transmission will be strong enough to reach about the defined space such as a football arena, but not significantly further.

By selecting a different frequency to be employed by modulator 404 from event to event, a fan 110 can be discouraged from trying to bring a receiver 112 purchased at one event to a subsequent event. For example, consider a situation in which the transmitter of FIG. 4A is used at a football arena that houses ten home games a year. If at the first home game a first frequency is used as a carrier signal, a fan 110 wishing to receive the transmission would be required to have a receiver designed to receive a signal carried by at that frequency. If at the second home game the frequency used as a carrier signal by modulator 404 is selected to be a second frequency (different from the first frequency), then a receiver 112 purchased by a fan 110 at the first home game would not be useful to receive the signal transmitted at the second home game. Therefore, fan 110 would be obliged to purchase another receiver 112 at the second game if he wished to receive the transmitted sounds from the playing field. Thus, by changing the frequency at which the transmission will be carried from game to game or from event to event, a fan can be discouraged from only purchasing a single receiver, rather than purchasing a receiver at each event.

FIG. 4B depicts a transmitter 411 employing digital transmission and direct sequence spread spectrum technology. This type of transmitter may be useful for at least the following reason. It is possible that, if the transmitter 411 of FIG. 4A were employed using simple amplitude modulation or frequency modulation, a fan could receive the transmitted signal by bringing a scanner to the game, thereby receiving the broadcast service for free. To minimize that risk, the modulator 404 shown in FIG. 4A could use a modulation technique not ordinarily employed by scanners, such as phase modulation. However, even that would have certain drawbacks. The spectral space in which the transmitter of FIG. 4A is likely to be permitted to transmit in by the FCC is likely to be limited. Therefore, there will only be a limited number of carrier frequencies from which to choose. It follows, then, that at some point over a certain number of games, carrier frequencies may have to be reused, in which case a fan could use a receiver he had purchased from a previous game to receive the broadcast. However, the transmitter 411 depicted in FIG. 4B uses both carrier frequency and spreading code set as variables which can be altered to determine the transmission protocol. Therefore, a greater number of transmission protocols can be employed by using the transmitter depicted in FIG. 4B.

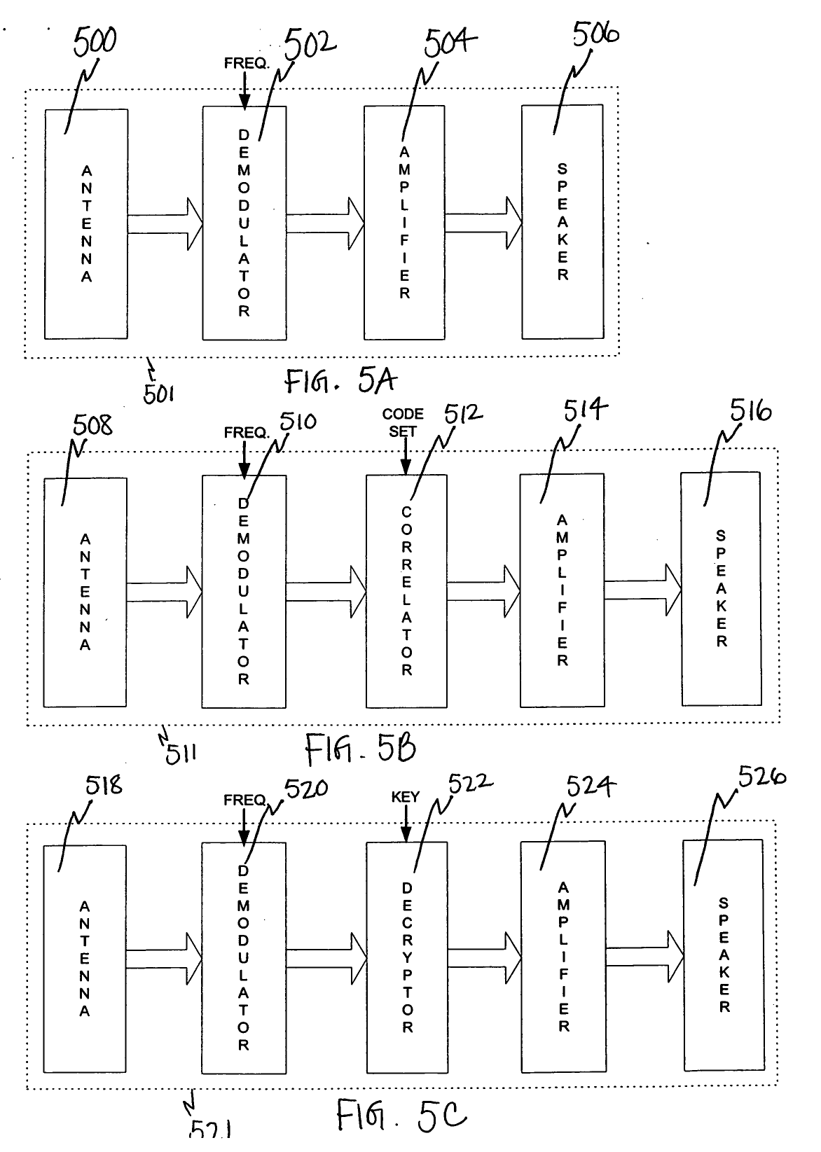

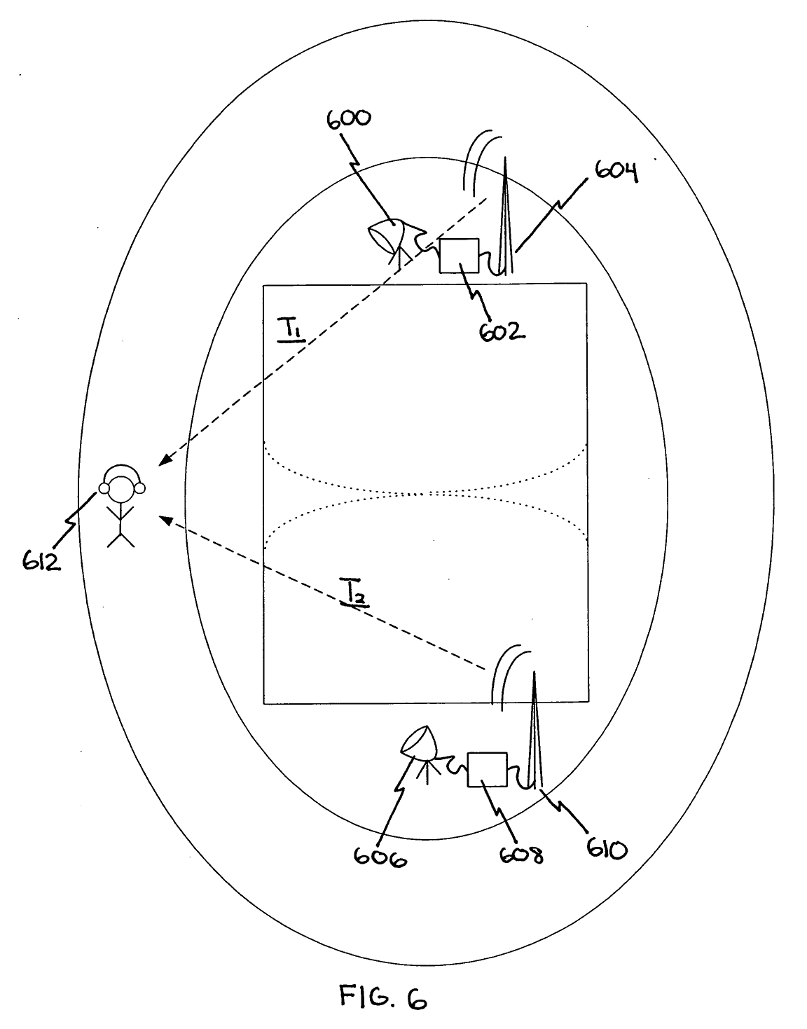

Like the transmitter 401 of FIG. 4A, the transmitter 411 of FIG. 4B is able to receive multiple audio signals 400. Also like the transmitter of FIG. 4A, the transmitter of FIG. 4B employs a mixer 402 that is capable of adjusting the relative signal strength of the multiple audio signals received by its input stage. Mixer 402 also may also employ switches enabling the mixer to completely turn off certain audio sources. The output of mixer 402 may contain a filter to eliminate signal content and frequency ranges that are undesired. Mixer 402 may also be embodied in an electrical component separate from transmitter 411. Sampler 410 is connected to the output stage of mixer 402 for the purpose of periodically sampling and thereby digitizing the output of the mixer 402. Sampler 410 delivers its digitized signal to spreader 412. Spreader 412 receives a signal that has been sampled at a certain number of samples per second and using a set of codes, breaks each sample into a larger string of ones and zeros known as “chips.” Because the signal when expressed with chips contains more chips per second than bits per second, the Nyquist frequency of the chipped signal is greater than the Nyquist frequency of the sampled signal and therefore has a wider spectrum. As will be shown in FIG. 5B, a receiver employing direct sequence spread spectrum technology must employ the same codes as the transmitter in order to receive the signal. The signal from the spreader 412 is then fed to modulator 414, which like the transmitter of FIG. 4A, uses a selectable frequency to set the frequency of the carrier signal that is being modulated against the output from the spreader 412. The signal generated by modulator 414 is then fed to amplifier 416, which amplifies the signal to a signal strength sufficient to broadcast the signal via antenna 418 throughout the enclosed space such as a football field without extending significantly further.

The transmission protocol employed by the transmitter 421 of FIG. 4C is defined by the frequency of the carrier signal selected by the modulator and the key used by an encrypter container within the transmitter. Like the transmitter of FIG. 4B, the transmitter 421 illustrated in FIG. 4C can receive multiple audio signals on its input. Also like the transmitter of FIG. 4B, the transmitter 421 of FIG. 4C contains a mixer 402 at its front end. The mixer 402 has the ability to adjust the relative signal strength of its multiple audio inputs. Mixer 402 may also have switching ability so as to be able to turn on and off a particular audio source or sources. The output stage of mixer 402 may have a filter designed to attenuate signal components in frequency ranges that are undesired. Mixer 402 may also be embodied in an electrical component separate from transmitter 421. The output stage of mixer 402 is fed to a sampler 410 that samples the mixed signal at a particular rate, thereby producing a digitized signal. The digitized signal is then fed to an encrypter 420. The operation of encrypter 420 is determined by the encryption key that it employs. The encryption key is programmable so that it may be changed from use to use and therefore from event to event. The output of encrypter 420 is an encrypted digital signal that is fed to modulator 422, which modulates a carrier signal of a selectable frequency. The output of modulator 422 is delivered to amplifier 424, which amplifies the signal to a certain signal strength sufficient to reach throughout the defined space, such as a football stadium, when transmitted by antenna 426.

Like the transmitter of FIG. 4B, the transmitter 421 of FIG. 4C is able to employ relatively more transmission protocols in a finite spectral space because its transmission protocol is defined by frequency and one other variable, in this case an encryption key. As will be seen in the discussion related to the receiver revealed in FIG. 5C, a receiver intended to operate with this transmitter must use the same encryption key or a matched decryption key in order to properly receive the transmitted signal.

The transmitters 401, 411, 421 depicted in FIGS. 4A-4C may be fixed or may be mobile and are presented as examples of transmitters that may be suitable for such an application. One skilled in the art would understand that many such transmitters would be suitable for this application.

FIGS. 5A-5C depict receivers 501, 511, 521 suitable for embodying the method and apparatus depicted in FIGS. 1-3. FIG. 5A depicts a receiver 501 suitable for receiving a signal transmitted by the transmitter 401 of FIG. 4A. FIG. 5B depicts a receiver 511 suitable for receiving a signal transmitted by the transmitter 411 of FIG. 4B. FIG. 5C depicts a receiver 521 suitable for receiving a signal transmitted by the transmitter 421 of FIG. 4C.

The receiver 501 of FIG. 5A has an antenna of appropriate geometry to receive a signal transmitted at the particular carrier frequency used by the transmitter of FIG. 4A. The output of antenna 500 therefore contains the modulated carrier signal that was output from amplifier 406. Demodulator 502 has its input stage coupled to antenna 500, thereby receiving the aforementioned carrier signal. Demodulator 502 takes the modulated carrier signal and restores it to its baseband form. The output of demodulator 502 may contain a filter or set of filters intended to remove signal components of undesired frequency ranges. The operation of demodulator 502 can be controlled by selecting the frequency it uses to demodulate the received signal, thereby allowing the receiver 501 to operate under a transmission protocol suitable for receiving the transmission of the transmitter depicted in FIG. 4A. At its input stage, amplifier 504 receives a signal emanating from the demodulator 502. Amplifier 504 amplifies the signal to a suitable signal strength so that the user of this receiver is able to hear the signal coming out of speaker 506.

The receiver 501 depicted in FIG. 5A may be disposable or may be recyclable. The receiver of FIG. 5A may also be optionally fashioned in the form of an earpiece or personal speaker of some form to permit only one user at a time to listen to the signal produced by speaker 506. In fashioning the receiver 501 of FIG. 5A in this manner, each member of a party will be forced to purchase the receiver of FIG. 5A in order to enjoy its associated service.

The receiver 511 of FIG. 5B has an antenna 508 of suitable geometry to receive the signal transmitted by the transmitter of FIG. 4B. Therefore, the output of antenna 508 contains the modulated carrier signal delivered by amplifier 416. Demodulator 510 is coupled at its input stage to the antenna 508. Demodulator 510 takes the signal encoded on the carrier signal and restores it to its baseband form. The operation of demodulator 510 is determinable by selecting the frequency used to demodulate its input. The output of demodulator 510 may contain one or more filters designed to eliminate signal components having undesirable frequency ranges. The output of demodulator 510 is therefore a sequence of chips, otherwise known as a “spread spectrum signal,” and is fed to correlator 512. Correlator 512 correlates the spread spectrum signal provided by demodulator 510 against a set of spreading codes, thereby yielding the original unspread signal. The operation of correlator 512 is determined by the code set against which the correlation is performed, and may therefore be selectable by programming the code set. The output stage of correlator 512 may include digital-to-analog converter to restore the digital signal to an analog form, and may also include one or more filters to remove signal components having frequency ranges that are undesirable. Amplifier 514 receives the signal emanating from correlator 512. Amplifier 514 amplifies the signal strength of its input so that the user of the receiver depicted in FIG. 5B is able to hear the signal when it is played by speaker 516.

The receiver 511 depicted in FIG. 5B, like the receiver 501 depicted in FIG. 5A, may be fashioned in the form of an earpiece or some form of personal listening device so as to permit use by only one fan or person at a time. Also like the receiver 501 of FIG. 5A, the receiver 511 of FIG. 5B may be disposable or may be recyclable.

The receiver 521 of FIG. 5C has an antenna 518, the geometry of which is designed to permit the antenna 518 to receive the signal transmitted by the transmitter of FIG. 4C. Accordingly, the output of antenna 518 contains the modulated carrier signal delivered by amplifier 424. Demodulator 520 receives at its input stage the signal from the antenna 518 and, like demodulators 502 and 510, demodulator 520 has a selectable frequency to permit demodulation of signals centered about various carrier frequencies. Demodulator 520 may have a filter or set of filters on its output stage to attenuate signal components having undesirable frequency ranges. The output of demodulator 520 is fed to decrypter 522. The operation of decrypter 522 is controlled by a selectable key. The key used in conjunction with decrypter 522 should be the same key used by encrypter 420, or should be a matched key. The output stage of decrypter 522 may have a digital-to-analog converter to restore the decrypted digital signal to its original analog form. The output stage of decrypter 522 may also have one or more filters designed to eliminate signal components in unwanted frequency ranges. The input stage of amplifier 524 receives the signal delivered from decrypter 522. Amplifier 524 operates to amplify its output to a signal strength, such that the user of the receiver depicted in FIG. 5C will be able to hear the audio signal when the output of amplifier 524 is played through speaker 526.

The receiver 521 of FIG. 5C, like the receivers 501, 511 of FIG. 5B and 5A, may be fashioned as an earpiece or any form of personal listening device for the same reasons as stated above. The receiver 521 of FIG. 5C may also be either deposable or recyclable.

The receivers 501, 511, 521 depicted in FIGS. 5A-5C may be fashioned to be operable for a set of events, such as an entire season of sports events. For example, rather than being configured for usage during a single event (such as a football game), the receivers of FIGS. 5A-5C receiver may be configured to use a particular protocol for an entire season. Alternatively, the receivers 501, 511, 521 of FIGS. 5A-5C may be configured to permit use of a range of pre-scheduled protocols identified for use during a season of events (such as an NFL season). For example, if it were determined that a particular professional football team would use ten protocols during ten home games, the receivers 501, 511, 521 of FIGS. 5A-5C may be configured to selectably operate under those ten protocols. Thus, a fan would be enabled to purchase a single receiver and yet receive the service for an entire season.

FIG. 6 illustrates the principle that the sound collected by various audio collection units can be transmitted simultaneously during the same event, yet transmitted under different transmission protocols, thus allowing a recipient of the service to choose among the various audio collection units for reception. As can be seen from FIG. 6, audio collection unit 600 receives sound from one region of the playing field, while audio collection unit 606 receives sound from another region of the playing field. Although FIG. 6 shows the various audio collection units collecting sound from various regions of the field, it is possible that audio collection units could be used to collect sound from, for example, a home sideline and a visiting sideline, an offensive huddle and a defensive huddle, or a home dugout and a visiting dugout.

As shown in FIG. 6, each audio collection unit 600, 606 is connected to its own signal conditioning unit 602, 608 and transmission unit 604, 610. As can also be seen, each transmission unit 604, 610 operates under its own transmission protocol. A fan using the service wears receiver 612, and can choose to tune into one transmitter or the other. This fan's choice could be aided by the distribution of a menu that allows the fan to know which transmission protocol correlates with which audio collection unit. For example, upon entry of a stadium, a fan could be passed a menu revealing that transmission protocol #1 will allow him to listen to an offensive huddle, transmission protocol #2 to a defensive huddle, protocol # 3 to a visiting sideline, transmission protocol #4 to a home sideline, and transmission protocol #5 to the region of the field where the ball is, and so on.

Although FIG. 6 shows each audio collection unit 600, 606 being connected to its own signal conditioning unit 602, 608 and its own transmission unit 604, 610, each audio collection unit 600, 606 could be connected to a single central signal conditioning unit which could be connected to a single transmission unit which would transmit each signal collected by each audio collection unit using different transmission protocols.

The system and method of FIG. 6 could be implemented using the transmitter and receivers shown in FIGS. 4A-4C and FIGS. 5A-5C so that the transmission protocol could be defined based upon either purely frequency, or a combination of frequency and spreading code set or a combination of frequency and encryption key. A user of the service would then wear the receiver 612 and select either simply the frequency that he wished to tune in or the frequency in combination with the spreading code set or the frequency in combination with the decryption key.

The systems and methods shown in FIGS. 1-6 share some common properties. For example, the transmission shown by the method and system of FIGS. 1-6 is contemporaneous with the event from which the sound is being collected so that minimal delay is introduced between the collection of the signal and the transmission of the signal. In other words, a fan receiving the transmission and watching the game would notice little delay between the events witnessed and the sound transmitted to him. Another property shared in common by the systems and methods in FIGS. 1-6 is the absence of two-way communication. In other words, the user of the service has no ability to communicate with the transmission unit. Another characteristic shared in common by the systems and methods of FIGS. 1-6 is that the sound being transmitted is the result purely of the sound being collected from on or about the playing field or area of interest, and does not include a narrative of the event, as would be found in a conventional radio or television broadcast. Stated otherwise, the sound being transmitted is, in large part, the sound being collected from the audio collection units, with few additions. It is contemplated, however, that advertising could be transmitted between plays, for instance, or that other insignificant sound could be mixed with and transmitted with the sound collected from the field.

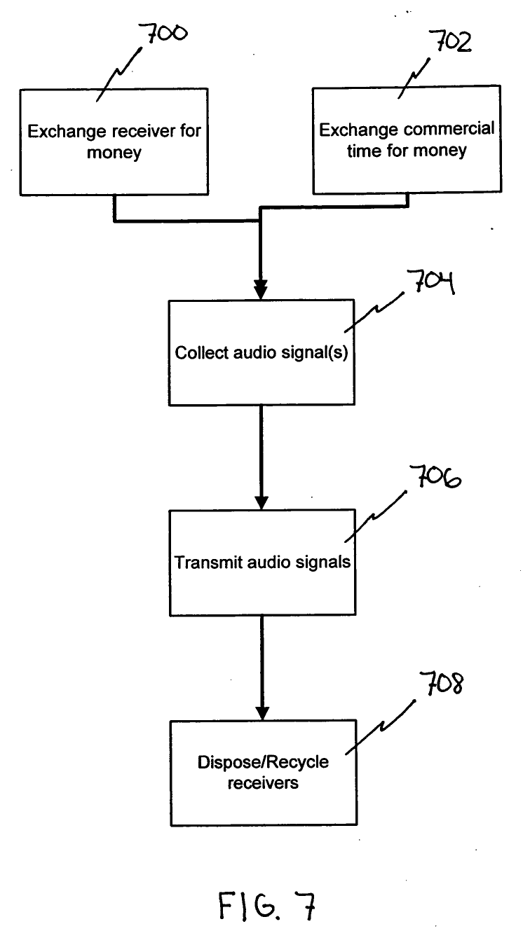

FIG. 7 illustrates one particular business method by which the systems and methods described in FIGS. 1-6 could be employed. As can be seen in FIG. 7, at least two profit models could be employed. In operation 700, a profit model is employed whereby each fan purchases a receiver, if that fan desires to be a recipient of the broadcast service. In operation 702, a profit model is shown wherein commercial time is sold to those who would wish to purchase advertising. Commercial transmission may take place at various intervals during an event such as between plays, during scheduled commercial breaks, between quarters and during halftime, between periods or innings, etc. Operations 700 and 702 could be employed conjunctively, meaning that one could both sell the receivers and sell commercial time. Operations 700 and 702 could also be employed disjunctively, meaning that one could either sell the receivers or sell commercial time, without doing both. Operation 704, which follows either the conjunctive or disjunctive performance of operations 700 and 702, requires that the audio signal of the particular event be collected and subsequently transmitted to receivers located within the space defined by the arena, stadium, theater, etc. in operation 706. Operation 708, which is performed at the termination of the service, shows that the receivers may either be disposed of or recycled. If a recycling model is used, fans could return the receivers in exchange for the return of a deposit and receivers could be reprogrammed at a later time with a different set of transmission protocols.

There are many additional enhancements to the device and new uses therefore which are set forth below:

Receivers can also function with card activation/authorization by using/requiring a card, chip, even merely a code, which is transmitted from the card to the receiver to authorize its use once, for several events, or other combinations thereof. In the case of a card activation, the user's attendance ticket may be the activation card and after the game can be a source of memorabilia. During the game, it can be a security attendance card which is visible as a hang tag hanging form the receiver which has a lanyard tether.

The activation card can include a code, chip or other indicia which a reader on the received can identify as valid for the current event. Likewise, the card may simply include a code or serial number, a key like notch (or notches) which are read into the receiver and the transmitter will authorize on those receivers which have valid codes for that particular event. Thus the user can reuse the receiver at multiple events but simply buy new activation cards.

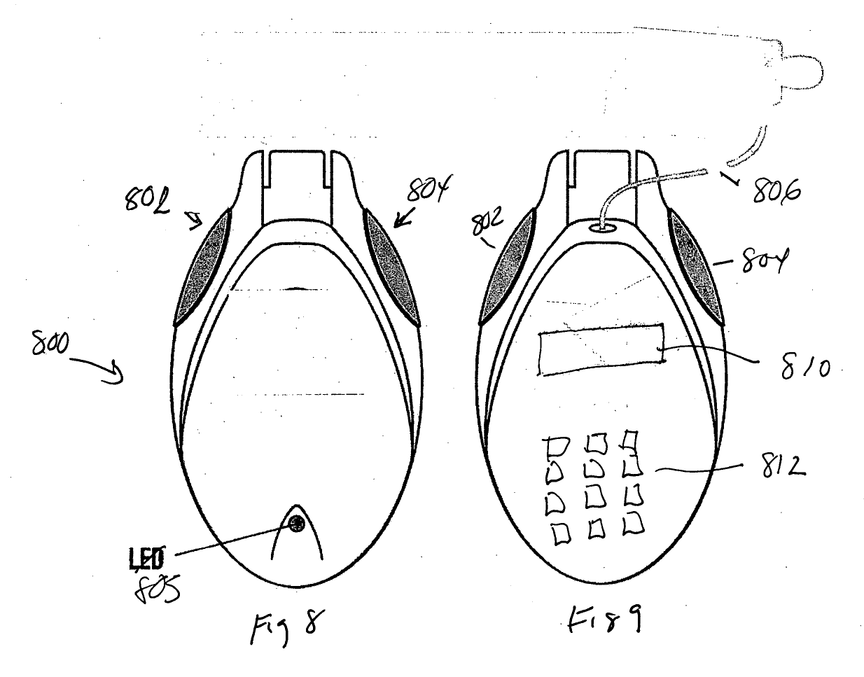

FIGS. 8 and 9 illustrate such a receiver/transceiver 800 with side rocker switches, 802 for example can be used for volume up/down and 804 for channel up/down. An LED 805 may be provided to show a positive link (authorized card). Alternatively, a read out screen 810, LCD, plasma, LED, or whatever technology may become available, may be provided. This will make it possible to use the screen information to create multi-function soft switches and provide written information in addition to audible signals to the headphones.

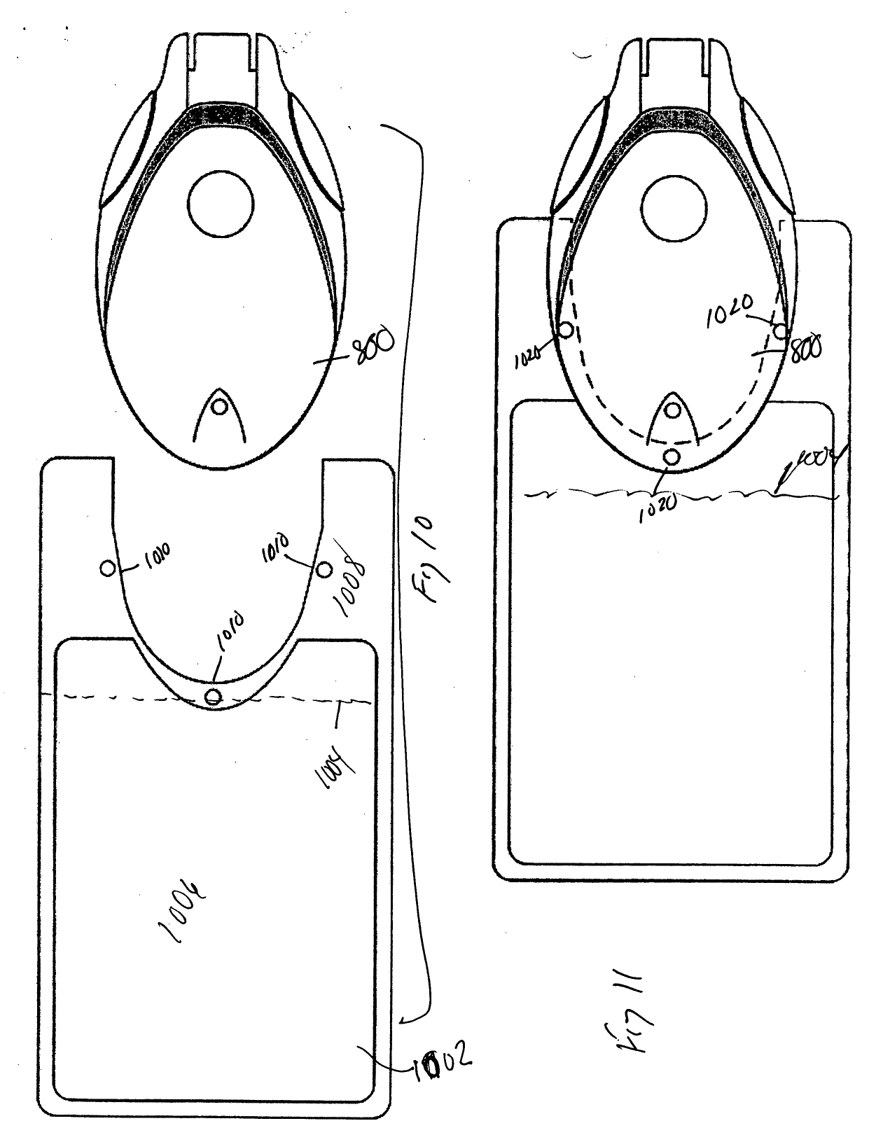

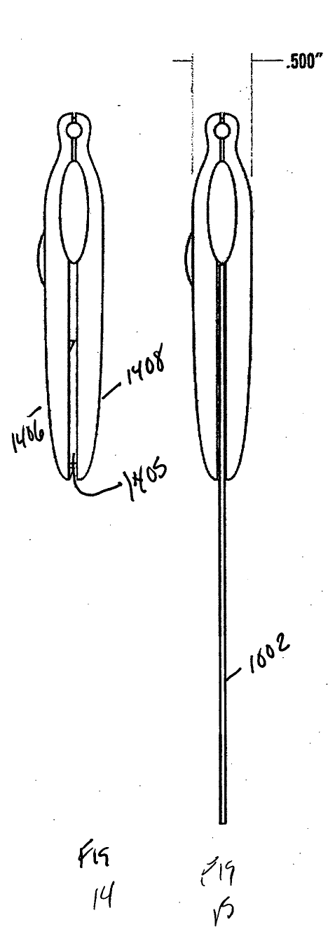

FIGS. 10 and 11 illustrate one embodiment using cards. Card 1002 is insertable into the receiver/transceiver 800 along an aperture in its edge 1405 (see FIGS. 14 and 15 for a side view). The receiver 800 is preferably designed of two halves 1406 and 1408 with a gap/slot 1405 therebetween for receiving the control access card 1002. The card may have a plurality of engagement points 1010 which engage like projections 1020 in the gap 1405. There are many possible systems for engagement. In this case, the card has holes and both halves 1406-1408 of the receiver and has projections which removeably engage the holes. Many other systems can be used. Not shown is that the card may have an embedded chip (or other means of authorizing the receiver) and that its contacts with likewise made with the receiver thereby authorizing the receiver for use by supplying needed information (code) and perhaps debit card information. This technology is well known in the art as “chip” or “smart” cards used chiefly by telephone companies. The basic concept is that the card carries data which will authorize the receiver to become operational for a fixed event or period of time, or both.

As will be explained below, the card 1002 has a potential as a collectible and thus in the preferred embodiment a portion thereof 1006 is detachable from the card along a perforation line 1004.

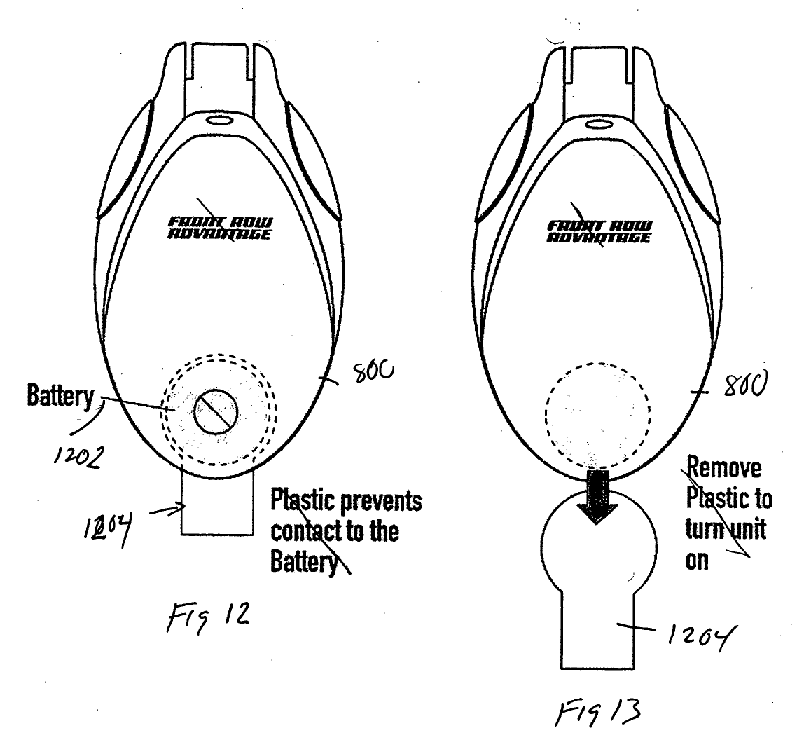

In one embodiment of this invention, the receiver is considered disposable and thus it is necessary to limit the current flow until activation is required, as shown in FIGS. 12-13. To accomplish this, the receiver has a battery 1202 which has one electrode interrupted by a non-conductive paper/plastic release tab 1204 which is accessible through the gap 1405. Removal thereof completes the circuit and the system is active until the battery runs out or the card is removed. In an alternative embodiment, the battery is replaceable by virtue of an openable compartment. The activation system can be replaced with a switch.

The receiver has been heretofore identified as only capable of receiving signals, but it is likewise possible to transmit information from the receiver and thus it may also be a transceiver (and thus the term receiver should be read as both). There are many modes of transmission possible including radio, Infra Red (IR), or other technologies currently available, or which may become available in the future. IR for example could be practical because of its low power requirements, simplicity and that IR receivers could be located in the dome of the arena or in nearby seats, possibly with or as repeaters. Multi-mode transmission may also be desirable. For example, VHF/UHF radio reception would be reliable and provide the necessary bandwidth, while transmit cold be done one Infra Red (IR) by beaming LED signals to receivers overhead. The cost and power requirements of IR transmission may make it the preferred method of transmission.

With a two way system, many additional functions of the transceiver can be achieved.

One which is sure to be very popular is remote ordering of food or beverages. The transceiver being uniquely encoded by the above card (or by its own serial number which could also be linked to the credit card) used to purchase the coded activation card 1002, in FIG. 10, may already be capable of knowing the attendee's specific seat location (if not, it could be detected by seat specific emitters/transponders adjacent each seat). The transceiver would preferably include a numeric or full key touch pad 812 and screen 810 (though voice interactive command may also be used). The menu of food/beverage options could be displayed on the LCD screen on a scoreboard like screen in the arena with numbers corresponding to items for purchase. A user could order selections and receive confirmation of price from a screen on the unit or by voice interactive thru the headset (eliminating the need for a screen). The user could then pick the preordered food/beverage quickly at a quick pre-ordered pick up station in the hallway, or a courier could deliver the items to the specific seat to which the transceiver is assigned. This would eliminate shouting by vendors and passing of cash down long isles.

Payment could be made by the usual cash means, but the coded access card 1002 could also be associated with the user's debit or credit account so that payment would be automatically deducted from the value deposited on the card or debited to an account. The debit prepaid card system would be highly desirable for the arena owner as redemption is always well below 100%. A discount for prepaid amounts applied to the card would be a significant incentive to the purchaser yet the arena owner would almost always accrue a financial advantage.

If the headset is bi-aural (i.e. has right and left earphones) it is possible to allow transmission of one channel in each ear. The user can squelch either one by switch control (or merely push one earphone aside to concentrate on the remaining channel). This could be useful in sporting events where play by play audio is on one channel and on the field talk is on another.

It is possible to have a multi-channel system with more than two channels which are user-priority ranked. For example, if play by play is a first priority, but quarterback chatter (football) is ranked higher, the system would always override the play by play with the preferred chatter channel. The user, by means of switches or even the activation card, may preset a series of channels according to preference and they can either take advantage of the bi-aural headset or simply supersede the lower ranked channel altogether.

The readout screen, such as LCD 810, may be on its own channel as well and statistics of particular player can be displayed in connection with the audio channel/stream selected for entirely independent thereof. For example, if the event is an NHL hockey game, the readout could display the scores of other games in the league.

With the transceiver model, many other uses for the device are possible. Users could use the switches 802-804 as multifunction voting buttons or provide other input. This could greatly enhance the participant experience. In sporting events, the users could vote a favorite player of that game/season, vote on the accuracy of calls by the referees (event officials), favorite commercial, etc., and engage in other interactive experiences whose outcomes could be reported on the scoreboard or by voice/data back to the transceiver.

If advertising to the user was allowed, the user could have specific targeted messages displayed on screen 810 based on known purchasing or voting patterns.

Loyalty programs, which reward the user for making purchases or even using the receiver/transceiver, could be further incentive to use the device and buy a prepaid debit version of the access card. Points accumulated could be used for discounts or to purchase future game activation cards, etc.

In jurisdictions where gambling is allowed, the transceiver mode could be used to place bets from the user's seat. Debits and credits to the user's prepaid card would eliminate the need to get out of seat to collect winnings. A tally of wins and losses could be provided by email to the user at the conclusion of the event which would be helpful for tax purposes in offsetting gains against losses. The tax authorities of a particular jurisdiction might actually require such record keeping.

While the concept of a separate receiver/transceiver has been discussed, it is possible to integrate this concept into existing handhelds such as cell/mobile phones and PDAs and iPod-like devices. Many handheld devices include input ports (memory cards/sim chips, etc.) which could receive an adapter to receive and read the coded activation card, in the case of a cell phone which has its own transceiver, or an adapter which is both a card reader and a receiver/transceiver. In the case of cell phone devices, which are characterized as transceivers, with agreement with the cell phone service providers, audible singles and text messaging could function in the same way as the above described receivers. A coded access card reader attachment would be used for authorization of the broadcast, though, since the cell service providers already have links to the users credit/debit cards and other forms of activation are possible. For example, the user could purchase an access number (such as by a scratch off card at the stadium, or in advance by phone or internet). The access number could be inputted into the cell phone by direct entry or by sending a text message to an authorization center.

Using existing handhelds, with full motion screens would allow this system to be built at lower cost and provide greater functionality. For example, if a card reader/received module is attached to a cell phone, number touch pad or screen need be provided, but full audio and even full motion video could be transmitted to the phone to show instant replays, etc. So one version of the invention is that it attaches to an input/output port of a handheld device and may use the card access system of the embodiments indicated above or may use another authorization system.

Much discussion of this invention has been directed to sporting or spectator-like events, but the invention has uses well beyond such events.

For Example:

Tour groups, often in large open noisy spaces, may have difficulty hearing their tour leader when spread out over a large area or the tour leader may be required to whisper (such as in churches). Likewise the tour participants may not all speak the same language, even though the tour leader may be multi-lingual. Therefore, the present invention may have multiple communication channels, the selection of which may be determined by a switch or by purchasing an appropriate language coded access card which selects language or other parameters. It would be convenient if the tour guide could specifically direct his/her talk in each language to each linguistic group separately. Finally, a tour guild may wish to integrate information provided at the site (museum/historic site, etc.) into his/her talk. Specific exhibits may include short range transmitters broadcasting sound clips so that the user can select by switches to receive such transmissions and they walk into range. The LED 805 or screen 810 may be programmed (like caller-id) to indicate the availability of these segments and the user can select a separate channel to play them.

The readout could be used in connection with gaming environments, such as horse racing to provide read time betting odds on a the horses currently running and in the transceiver version, bets can be placed from the transceiver. The audio could include a channel for race track action, but also channels “behind the screens” with interview of trainers, owners, etc, before the race.

Movie theaters (cinemas) may find such a system likewise useful to provide talking commentary by the director, for foreign languages sound tracks or many other points of differentiation.

In addition to the above needs, event organizers are always looking for revenue enhancement opportunities. A system which provided revenue by sales of equipment and memorabilia would be highly desirable. There is already a healthy market for the sale of ticket stubs from prior games and the sports teams are working to enhance the collectibility of such stubs through the use of photo and holographic images, etc. The coded access card 1002, may also include a perforated line 1004 below which, in portion 1006, a collectible card/stub is located. This access card could also be the sports admission card. The upper portion 1008 may in this embodiment, contact the control access features (such as a chip, circuit, scannable data, etc.) and would be discarded after the event as unusable thereafter.

In addition to on the ground sounds, there are opportunities to capture “back stage” or locker room talk of the players. It would likewise enhance the experience to capture and transmit such sounds to the attendees.

Attendees can also be distracted during events (often by noise/cheering etc.) and miss an important phrase, signal, call or play. It would be extremely helpful if a device could record and playback a short previous segment of the event. This would be quite convenient in a movie, for example where, a critical line may be missed by a distraction, such as a crying baby, another attendee talking loudly or just the distraction of a spilled soft drink at a critical moment. A similar circumstance could arise in a college lecture where taking notes may distract the listener from hearing a key phrase.

At an arena event, there are always unsold seats. There needs to be an orderly way to allow attendee to switch seats. It would be useful for an attendee, by selective broadcast (coded) to be advised of the exact seat location of an empty preferred seat without disturbing or advising others. The seat upgrade could also generate revenue.

Attendees at events (fans) often wish to purchase food at the event (indeed it may the highlight of the event), but many arenas/stadiums have very poor aisle access making if cumbersome to get up and leave to purchase food. An interactive system coded to know the purchaser's seat location would be helpful in pre-ordering (for pickup or delivery) of food or other purchasable items.

Attendees often bring their own radio to receive play-by-play or commentary about the event. It would be helpful if a device was available which could integrate the above on the ground sounds with radio broadcasts and prioritize either according to user tastes.

Legal and other restrictions on the transmission of on the ground sound (play action) may be necessary to prevent opposing teams from graining advantage from such information. Thus a system (such as a proximity system) which could restrict which sounds can be re-transmitted to attendees and which need to be squelched would be desirable. For example, a coach talking to a team player may need to be suppressed from rebroadcast.

In addition to on the ground sounds, there are opportunities to capture “back stage” or locker room talk of the players. It would likewise enhance the experience to capture and transmit such sounds to the attendees.

Attendees can also be distracted during events (often by noise/cheering, etc.) and miss an important phrase, signal, call or play. It would be extremely helpful if a device could record and playback a short previous segment of the event. This would be quite convenient in a movie, for example where a critical line may be missed by a distraction, such as a crying baby, another attendee talking loudly or just the distraction of a spilled soft drink at a critical moment. A similar circumstance could arise in a college lecture where taking notes may distract the listener from hearing a key phrase.

At an arena event, there are always unsold seats. There needs to be an orderly way to allow attendee to switch seats. It would be useful for an attendee, by selective broadcast (coded) to be advised of the exact seat location of an empty preferred seat without disturbing or advising others. The seat upgrade could also generate revenue.

Attendees at events (fans) often wish to purchase food at the event (indeed it may be the highlight of the event), but many arenas/stadiums have very poor aisle access making if cumbersome to get up and leave to purchase food. An interactive system coded to know the purchaser's seat location would be helpful in pre-ordering (for pickup or delivery) of food or other purchasable items.

Attendees often bring their own radio to receive play-by-play or commentary about the event. It would be helpful if a device was available which could integrate the above on the ground sounds with radio broadcasts and prioritize either according to user tastes.

Legal and other restrictions on the transmission of on the ground sound (play action) may be necessary to prevent opposing teams from graining advantage from such information. Thus a system (such as a proximity system) which could restrict/prohibit which sounds can be re-transmitted to attendees and which need to be squelched would be desirable. For example, a coach talking to a team player may need to be suppressed from rebroadcast. This could be accomplished by GPS (global positioning system) or by local triangulation systems in covered structures.

Likewise, tour groups may have difficulty hearing their tour leader when spread out over a large area or the tour leader may be required to whisper (such as in churches). Likewise, the tour participants may not all speak the same language and even though the tour leader may be multilingual, it would be convenient if the tour guide could specifically direct his/her talk in each language to each linguistic group separately. Finally, a tour guild may which to integrate information provided by the site (museum/historic site, etc.) into his/her talk. Sound clips may be available to the tour by short range radio and it would be desirable to be able to provide individual receivers which could tap into such feeds as the tour operator or participant desires.

Movie theaters (cinemas) may find such a system likewise useful to provide talking commentary by the director, for foreign languages or many other differentiations.

In addition to the above needs, event organizers are always looking for revenue enhancement opportunities. A system which provided revenue by sales of equipment and memorabilia would be highly desirable.

From the foregoing detailed description and examples, it will be evident that modifications and variations can be made in the devices and methods of the invention without departing from the spirit or scope of the invention. Therefore, it is intended that all modifications and verifications not departing from the spirit of the invention come within the scope of the claims and their equivalents.

The claimed invention is:

1. A method of delivering sound to a plurality of individuals, the method comprising the steps of:
collecting at least one acoustic audio signal generated at a first location;
collecting at least another acoustic audio signal generated at a second location
transmitting said audio signal to a receiver associated with at least one of said plurality of individuals; and
providing a user controlled prioritization system whereby the user can prioritize which of said signals will be transmitted to the user's receiver when in competition with each other.

2. The method of claim 1 wherein said second signal is a play-by-play broadcast of an event, and wherein said first signal is an on-the-playing-field audio signal.

3. The method of claim 2 wherein said on-the-playing-field broadcast, has priority over the other signals.

4. The method of claim 1 wherein the method is applied to a live event with on-the-ground performers and spectators and the step of collecting an acoustic audio signal generated at a first location comprises collecting an acoustic audio signal generated by placing microphones on at least one of the performers.

5. The method of claim 1 wherein the method is applied to a multilingual tour group and wherein the first acoustic audio signal is in one language and the second is in another language and wherein the user selects the preferred language.

6. The method of claim 1 wherein the method is applied to a museum-like facility characterized by users with receivers, a plurality of points of interest scattered about the facility, at least one of said points having a transmitter and a pre-recorded message, comprising the steps of:
broadcasting a running commentary of the points of interest in the facility on said first signal; and
broadcasting on said second signal, a plurality of commentaries associated with a plurality of geographically separated points of interest, said second signal having a limited radial extent; and
when the user is within the limited radial extent of a point of interest, prioritizing the second signal over the first signal, so that when the user is within said radius said at least one point of interest, the running commentary is replaced with said second signal, until said user leaves the override radius, at which time the commentary signal regains priority.

7. The method of claim 1 the method is applied to a cinema-like facility characterized by users with receivers, wherein said first signal is an audio track to the cinematic production and where said second signal is a running commentary thereof.

8. The method of claim 1 wherein the step of collecting an acoustic audio signal comprises using a parabolic microphone to collect an acoustic audio signal generated at a first location within a fixed space.

9. A method of delivering sound to a plurality of individuals, the method comprising the steps of:
collecting an audio signal generated at a first location;
transmitting, under a first transmission protocol uniquely associated with a particular event and first location, said audio signal collected from said first location to a receiver worn by at least one of said plurality of individuals within said fixed space;
receiving said audio signal with said receiver, wherein said receiver is configured to operate under said first transmission protocol continuously capturing and storing at least the last N seconds segment of said collected audio signal, where N is a period of time greater than zero;
providing a means by which the user can interrupt the audio signal and replay the last captured segment; and
reverting to said audio signal after the playback and continuing said capture and storage so that the users can self-select an instant replay of said segment.

10. A method of delivering sound to a plurality of individuals, the method comprising the steps of:
collecting at least one acoustic audio signal generated at a first location;
transmitting said audio signal to an earpiece worn by at least one of said plurality of individuals;
positioning microphones on a plurality of performers of the event;
establishing a set of prohibited conversational groups where conversations between certain predetermined performers shall be prohibited from inclusion into one of said audio signals; and
determining of said if an audio signal is detected from one of said prohibited groups blocking said conversations of said prohibited groups from being transmitted to said receiver.

11. The method of claim 10 including the step of detecting the proximity of performers included in the set of prohibited conversation groups.

12. The method of claim 10 wherein said detecting step is includes detection by global positioning.

13. The method of claim 10 wherein said detecting step includes detection by local triangulation.

14. The method of claim 10 wherein the transmission protocol comprises a transmission frequency uniquely associated with the particular event.

15. The method of claim 10, wherein:
the method further comprises the steps of:
collecting an audio signal generated at a second location within a fixed space;
transmitting, under a second transmission protocol uniquely associated with a particular event and said second location within said fixed space, said audio signal collected from said second location to a receiver associated with at least one of said plurality of individuals within said fixed space and at a distance from said first location; and
wherein the step of receiving said audio signal with said receiver comprises receiving said audio signal with said receiver, wherein said receiver is configured to selectably operate under said first transmission protocol or said second transmission protocol, thereby permitting an user of said receiver to select one of said first or second location within said fixed space according to user preference.

16. A system for delivering sound to a plurality of individuals, comprising:
one or more audio collection units for collecting one or more audio signals from one or more locations within a fixed space; and
one or more transmitters configured and arranged to transmit said one or more audio signals under one or more transmission protocols, such that each of said one or more audio signals is transmitted under its own transmission protocol, the transmission protocol under which each of said one or more audio signals is transmitted being uniquely associated with a particular event at least one personal receiver including a code selector, said code selector being associated with a particular event and when associated with the receiver, configures the receiver to the transmission protocol.

17. The system of claim 16 wherein said code selector is a card and wherein said receiver includes a card reader.

18. The system of claim 17 wherein said card is also the entry ticket to the event.

19. The system of claim 17 wherein said card includes a first portion which selects the code and a second removable collectible portion.

20. The system of claim 17 wherein said removable portion includes a discount coupon.

21. The system of claim 17 wherein the one or more transmitters are configured and arranged to employ a particular encryption procedure, such that an encryption procedure that is used for transmission of an audio signal collected from one of the one or more locations during a particular event is not re-used for transmission of another audio signal collected from another of the one or more locations.

22. The system of claim 16 wherein receiver include front and back faces joined together along an interface, and wherein said code selector includes a slot for receiving a code selection card.

23. The system of claim 22 wherein said card includes a code, readable by said receiver to authorize the receiver's operation.

24. A method of improving spectator experience at an event, comprising:
collecting at least one acoustic audio signal by attaching a microphone to at least one performer at said even;
transmitting said audio signal to a transceiver associated with at least one of said plurality of individuals, thereby allowing them to hear sounds of the event at the point of said performer;
advising the spectator of an interactive choice; and
providing means for the spectator to transmit a respond to said choice by sending a reply from said transceiver.

25. The method of claim 24 wherein the interactive choice is a menu of food items and wherein the user may select such items from said transceiver.

26. The method of claim 25 further including the step of associating the transceiver's location with a particular seat at said event, and delivering the food items to said seat in response to said order.

27. The method of claim 24 wherein the interactive choice is voting on a preferred performer.

28. The method of claim 24 wherein the interactive choice is voting on a decision of an event officiator.

29. The method of claim 24 including the step of establishing a credit balance associated with the transceiver and debiting the balance in connection with interactive responses.

30. The method of claim 24 including the step of establishing a link between the transceiver and a user's credit line and debiting the credit line in connection with interactive responses.
